(19) United States
(12) Patent Application Publication
(10) Pub. No.: US 2006/0156001 A1
(43) Pub. Date: Jul. 13, 2006

(54) Personalisation of security modules

(75) Inventor: Michael Nolte, Brakel (DE)

Correspondence Address: MICHAUD-DUFFY GROUP LLP, 306 INDUSTRIAL PARK ROAD, SUITE 206, MIDDLETOWN, CT, 06457, US

(73) Assignee: Wincor Nixdorf International GmbH, Paderborn (DE)

(21) Appl. No.: 10/535,699

(22) PCT Filed: Nov. 20, 2003
(86) PCT No.: PCT/DE03/03853

§ 371 Date: May 19, 2005

(30) Foreign Application Priority Data
Dec. 17, 2002 (DE) 102 59 270.5

(51) Int. Cl. H04L 9/00

(52) U.S. Cl. 713/175

(57) ABSTRACT

A security module, a personalization unit and a method for use thereof, where the security module contains a secret key from a key pair for asymmetrical encryption, and the personalization unit produces a certificate about the public key from the key pair and sends it to the security module together with the public key from a central system. The security modules uses this certificate and the public key to protect the communication with a central system, particularly in the field of banking.

### FIELD OF THE INVENTION

The invention relates to the personalization of cryptographical security modules.

### BACKGROUND OF THE INVENTION

For operating automated teller machines, in particular, security modules are used which comprise a cryptographical processor and a key memory. During operation of the automated teller machine, the security module cryptographically protects all messages from or to a central system. The key memory cannot be read from the outside, but rather may be used only for cryptographical operations, which means that once a key has been transmitted to the security module it can no longer be compromised.

This operation, called personalization, is critical from the point of view of security engineering. This applies particularly to the symmetrical encryption used to-date, e.g. the DES method, in which one and the same key is used for encryption and decryption. The manufacturer of the security module therefore needs a high level of complexity in order to protect the keys used from being discovered. In particular, personalization needs to be performed on secure-access premises by special personnel. When only a few master keys are used, a particularly high level of security complexity is needed. Customer-specific programming requires a high level of logistical and storage involvement, including the guarding of the store and transport.

It is an object of the invention to provide a method which allows the personalization to be performed immediately during startup by the customer himself at the place of use or in another not especially secure environment.

Patent specification U.S. Pat. No. 6,442,690 B1 describes a personalization system for a cryptographical module. In this context, the cryptographical module is provided with a provisional key. For the purpose of personalization, a check is first carried out to determine whether this provisional key is available, and if appropriate is exchanged for a new one. In this case, the new keys are provided by the personalization unit by virtue of key management. It also proposes the use of asymmetrical methods, which involve the use of a key pair comprising a public key and a secret key. The characteristics and advantages of asymmetrical methods over symmetrical methods are known from the relevant literature; knowledge of these is readily assumed below.

Patent specification U.S. Pat. No. 6,298,336 B1 describes a transportable activation appliance for chip cards with a payment function, the chip cards being unusable until they are activated for the envisaged applications in a cryptographically secure fashion.

Patent specification DE 199 19 909 C2 describes a method in which a message can be signed using symmetrical encryption and can be transmitted in plain text without the need for the station producing the signature to have the secret key.

### SUMMARY OF THE INVENTION

The invention uses the insight that a transportable personalization appliance which is of similar design to a security module and, in particular, contains a protected key memory and a cryptographical processor operating therewith allows the method described by the invention to be handled particularly advantageously. The use of chip cards, in particular, is advantageous, since these together with mobile computers make a portable personalization appliance readily available. If a personalization appliance of this type is connected to the security module in situ, then this alone provides a high level of security for the correct security module actual being personalized. One particular advantage is that the security module is already at the final location, and hence no further transport is required which would need to be protected by guards. In the preferred embodiment, there is additionally provision for reciprocal authentication of the security module and the personalization unit, involving the security module being provisionally initialized, but not personalized, by the manufacturer. This initialization may be the same for all modules, possibly apart from consecutive serial numbers.

What is involved is a security module, a personalization unit and a method for use thereof, where the security module contains the secret key from a key pair for asymmetrical encryption, and the personalization unit produces a certificate about the public key from the key pair and sends it to the security module together with the public key from a central system. The security module uses this certificate and the public key to protect the communication with a central system, particularly in the field of banking.

### BRIEF DESCRIPTION OF THE DRAWINGS

The sole FIGURE schematically shows the invention in context.

### DETAILED DESCRIPTION OF THE PREFERRED EMBODIMENTS

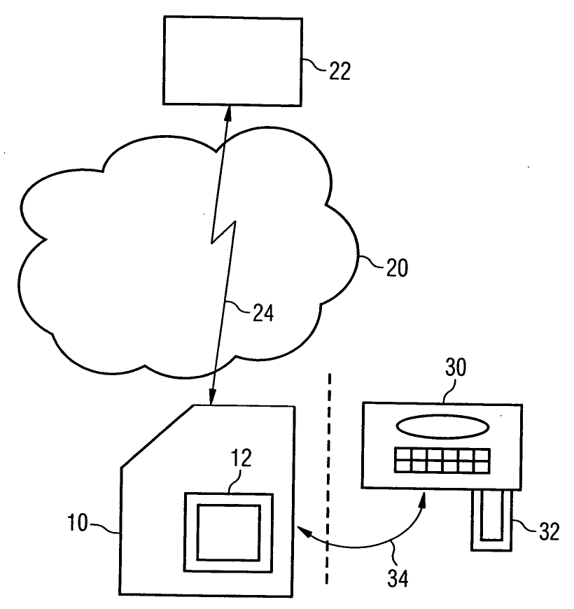

An automated teller machine 10 contains a security module 12 and is connected in later use to a central system 22 via a network connection 24 in a network 20. In addition, a personalization unit 30 is shown which has a chip card 32 having a cryptographical processor and a secure key memory. The dashed line in FIG. 1 is intended to indicate that the personalization unit 30 is placed only temporarily into the physical proximity of the security module 10 and is connected via the data connection 34.

The term 37 central system” is used generically for remote communication stations connected to the security module in the operating state.

The personalization unit is preferably a mobile computer which is equipped with a chip card as a cryptographical unit. This chip card comprises a secure key memory and uses the keys stored therein to perform the necessary cryptographical methods using data which are transmitted via an interface on the chip card. The key memory is protected to the extent that the protocol on the interface is monitored fully by the processor on the chip card and is in a form such that the secret keys from the key memory are not transmitted via the interface; it is merely possible to apply them to data. Accordingly, the integrity of public keys is produced either through storage in the key memory or by storing cryptographical hash values in the key memory. Even though the known embodiment as a chip card is preferred according to ISO, a processor card in the PCMCIA format or an external module connected by USB or Firewire may also be used. All of the software and the key memory may readily also be contained in the mobile computer itself, even though this is not the preferred embodiment on account of the lower security in mobile computers which are available at present.

In addition to the opportunity for cryptographical processing and the secure key memory, the personalization unit has a communication interface which can be used for temporarily setting up a connection to the security module. In the simplest case, this is a serial connection based on V.24, where a cable with connectors is temporarily plugged in and the connection is controlled by a user in this manner. Other data connections such as I²C, USB, Firewire etc. are equally possible. Wireless connections via infrared or radio, such as IrDA or Bluetooth, may be used equally well; in this case, there is no physical setup on a connection. Bluetooth has the additional advantage that encryption of the communication is built in, even though the key management is left to the application.

Cable and infrared connections have the advantage that the operator is able to ensure that the intended appliance is personalized if the connection is routed directly to the security module which is to be personalized. For many uses, this authentication may be sufficient, which means that the preferred crypto-graphical authentication described below can be dispensed with.

Following delivery and prior to the start of personalization, the security module is in a personalization state which differs from the subsequent operating state.

The connection between the personalization unit and the security module is preferably a cryptographically secure connection based on known methods, such as are known as TLS in connection with HTTPS, for example. Once the connection has been set up and is available, these methods ensure that the subsequent communication can be neither monitored nor modified. This is normally done using a random key which is provided either on the basis of the Diffie-Hellmann method without authentication or within the context of authentication, such as in line with the publication WO 91/14980 the contents of which are incorporated herein by reference. The security demands on the reciprocal authentication, which need to be ascertained for each instance of use, thus determine the demands on the authentication which is to be used. In this regard, said patent specification DE 199 19 909 C2, incorporated herein by reference, may also be of use, according to which the manufacturer can put a certificate into a security module without possessing the key for the verification. It is also possible for the manufacturer to equip every security module with a random key, which the accompanying documents contain or which is sent independently via secure channels. Reciprocal authentication then takes place using known challenge-response methods.

Once the secure connection has been set up between the security module and the personalization unit, the security module uses it to send the public key from a key pair whose private key is stored in its secure key memory. This key pair, subsequently also called module key, may be generated during actual manufacture, since the private key cannot leave the security module and therefore also cannot be compromised on the manufacturer's premises.

Preferably, the key pair is not produced until personalization, however, because then the influence of the manufacturer is less and hence its security proportions are less complex. In addition, a modifier (also referred to as ‘salt’ in the literature) prescribed by the personalization unit can be transmitted too and influences the key pair produced.

The security module now transmits the public key to the personalization unit. The latter uses the secret key (stored in it) from a further key pair, subsequently referred to as a signing key, and in so doing signs the public module key received from the security module. Such a signature for a public key, with or without this signed public key, is subsequently referred to as a certificate.

The personalization unit uses the existing secure connection to return the certificate to the security module, which stores the certificate permanently and such that it is protected against alteration for use in the operating state described below. In this case, as mentioned above, the integrity is protected by means of the secure key memory.

In one development of the invention, the personalization unit also returns, together with the certificate, a public key from a central system to which the security module needs to be connected in future in the operating state. Preferably, this public key is likewise provided with a certificate by the personalization unit, although the security module cannot check this certificate until the security module contains a secure public key from the personalization unit. The latter therefore thirdly sends its public key together with a further certificate. This certificate may either be issued by the central system and can then be checked with the likewise transmitted public key from the central system. This circular certification should be regarded more as a plausibility check, because the personalization unit is readily able to produce an arbitrary key pair for the central system itself and can then provide the necessary certificate.

A better approach is the solution in which the public key from the personalization unit has been signed by a further key pair from the manufacturer, the manufacturer having entered his public key into the security module during manufacture. The corresponding certificate is transmitted to the security module by the personalization unit.

Hence, it is then no longer necessary to authenticate the personalization unit to the security module when the connection is set up, since the personalization includes a check on the certificates transmitted by the personalization unit. The fact that the public module key may then possibly be read without authorization is not critical according to the principle of asymmetrical encryption. The manufacturer merely needs to sign the customers' signing keys as required and to enter its own public key into the security module.

If signing the signing key from the personalization unit means that data interchange takes place between the manufacturer and the operator of the personalization unit any way, then the public key from the manufacturer is also preferably interchanged too. The security module then produces a further key pair at the conclusion of the manufacturing process, said further key pair being permanently maintained and being used for securely identifying the security module. The associated public key is signed by the manufacturer, and the certificate is loaded into the security module. The security module is thus able to prove its identity, that is to say to authenticate itself, by signing its serial number and other data prescribed by the personalization unit, such as a time stamp and random numbers.

The connection between the personalization unit and the security module is now cleared down, and hence the personalization unit is isolated from the security module. The security module thus changes to the normal operating state, in which further personalization is not possible. Fresh personalization can be enforced by means of direct intervention in the security module (or else by a command, for example from the central system, which has been protected against misuse in whatever manner). However, this resetting to the personalization state entails the security module erasing the key pair and enforcing generation of a new key pair as part of the subsequent personalization.

In the operating state which follows personalization, a connection is now set up between the security module and the central system, said connection likewise being protected through cryptographical means, particularly session keys. In this context, the security module sends the certificate issued by the personalization unit to the central system together with its public key. The central system has previously been sent the public key from the personalization unit using an integrity-controlled connection. (By way of example, the chip card is personalized by the central system). The central system is thus able to check whether the security module is authorized for the subsequent transactions and, by way of example, is reliably able to convey the fact that an authentic bank card for a particular account number is available for paying a sum which has been sent at the same time. As a result of the security module having received from the personalization unit the public key from the central system, the security module again has the assurance that the messages received from the central system, e.g. the instruction to pay a sum of money, originate from an authorized central system.

For reasons of compatibility or speed, it is also possible for a symmetrical key to be transmitted from the central system to the security module, said symmetrical key then being entered into the secure key memory and being used for a limited time for transactions using previous methods based on symmetrical cryptography.

In the preferred embodiment, any personalization on the chip card is shown in a log. This ensures that the certificate issued can be reconstructed at any time. If the chip card is compromised, disabling the associated public key in the central system quickly provides an effective countermeasure.

A security module which has not been personalized by the invention needs no particular guarding either during storage or during transport, since it cannot be used without personalization. This means that the value of the module is not significantly above the manufacturing value either and is also not customer-specific.

Since the personalization unit in the preferred embodiment can be used only with a chip card as cryptography unit, only the chip card needs to be protected against misuse if the software is in an appropriate form. For this purpose, banks, in particular, have effective administrative methods available using the four eyes principle.

One variant of the invention uses the existing data network, which is necessary anyway in the operating state, to connect the security module to the personalization unit. This allows the personalization unit to be operated securely and also to be integrated into the central system. In the latter case, the transmission of the public signing key from the signing system to the central system (which transmission needs to be protected against corruption) is simplified.

In this case, appropriate protocol elements are used to set up a cryptographically secure (particularly against corruption) connection. As part of the secure identification and authentication, it is necessary to ensure that also the “correct” security module is personalized.

The first solution involves an operator using a temporary direct data connection to enter a one-off transaction number which is sent to the personalization unit. This transaction number can be transported in security envelopes and may comprise 16 or more characters, for example. The connection to the security module also does not need to be secure, since the transaction number becomes worthless immediately after input. It thus suffices to have a simple key pad with a simple serial interface which is connected temporarily to the security module. If the security module has a key pad anyway, for example for diagnostic purposes, then this can be used for inputting the transaction number.

For very long transaction numbers, a mobile computer having one of the interfaces indicated above is used. Preferably, the transaction numbers are then stored on a chip card, even though (encrypted) storage is likewise possible in the mobile computer's file system.

Alternatively, a mobile computer is used which conveys the secure identification. The mobile computer uses two data interfaces, one for local connections and one for long-distance connections. For the local connections, the devices already mentioned above which are used for temporarily connecting the personalization unit in the other variants are suitable. For the long-distance connections, either mobile radio connections or other network connections are suitable. It is likewise possible to route these connections via the local connection. The mobile computer may therefore also be a mobile telephone.

One variant of this conveyed identification produces a random number in the mobile computer and, on the one hand, sends it to the security module via the local connection, with the security module immediately forwarding it to the personalization unit. In parallel therewith, the random number is sent directly to the personalization unit via the long-distance connection. In the case of a mobile telephone, the caller number communicated by the network operator will suffice in order to provide adequate assurance of the identity of the mobile telephone. In the case of a general mobile computer, a secure HTTP connection using the TLS protocol is preferably used, in which case a chip card may also be used to protect the certificates used.

In this context, the identifying random number can be produced by any of the three appliances. Preferably, the random number is produced in the personalization unit, which sends it to the security module, which sends it to the mobile computer, which returns it to the personalization unit. Only then is personalization continued. In this case, the random number has the same function as the transaction number previously; it is not formed until required. Forming it in the personalization unit assures the quality. Accordingly, the random number may also be formed in the security module.

In this case too, a mobile appliance is temporarily connected to the security module and assures the personalization unit of the identity of the security module which is to be personalized.

In all of these variants, the security module is personalized by virtue of the public key from a key pair produced in the security module being certified by a certification unit. The certificate obtained in this manner is stored in the security module and is characteristic of the subsequent operating state. The authentication to the certification server is based on a temporary data connection between the security module and a mobile input unit which a user uses for this purpose.

1-21. (canceled)

22. A method for operating a security module, said method comprising the steps of:
providing a security module having a secure key memory and at least one data interface;
in a personalization state, setting up a connection to a personalization unit using the data interface;
using the security module to create a module key pair afresh and storing said module key pair in the key memory;
sending a public module key to the personalization unit via the connection;
using the personalization unit to produce a certificate relevant to the public module key by signing with a signing key from the personalization unit;
causing the personalization unit to send the certificate to the security module and storing said certificate securely therein;
clearing down the connection between the security module and the personalization unit; changing the security module from a personalization state to an operating state; and
setting up in the operating state, a cryptographically secure connection to a central system, said connection involving the use of a private module key and involving the public module key together with the certificate being transmitted to the central system, where the certificate is checked.

23. The method as claimed in claim 22, where changeover to the personalization state erases the module key.

24. The method as claimed in claim 22, wherein in the personalization state the connection between the security module and the personalization unit is checked cryptographically for authenticity and is protected against corruption.

25. The method as claimed in claim 22, wherein a public key from the central system is transmitted together with the module certificate, said public key being used in the operating state to check the authenticity of the central system.

26. The method as claimed in claim 25, wherein the public key from the central system is signed with the signing key from the personalization unit, and the resultant certificate is also transmitted and is checked by the security module.

27. The method as claimed in claim 26, wherein a signer's public signing key is signed by the central system creating another certificate, and this certificate is also transmitted and is checked by the security module.

28. The method as claimed in claim 22 wherein the key memory in the security module stores a public checking key from a manufacturer,
the personalization unit transmits its public signing key together with a certificate, formed with the checking key from the manufacturer,
and the security module first checks the public signing key's certificate with the public checking key and then checks the certificates produced with the public signing key,
and changes to the operating state only if the check is successful.

29. The method as claimed in claim 22 wherein the security module is used to form a permanent identity key on a one-off basis, the associated public key is signed with the checking key from a manufacturer, and the corresponding certificate is stored in the security module, and wherein the identity key with a certificate is used to assure the personalization unit of authenticity on the basis of a challenge-response method.

30. The method as claimed in claim 22, wherein the security module sends the personalization module one of a time stamp and a random value which is included in the signature when the certificates are formed.

31. The method as claimed in claim 22, wherein the personalization system sends a variation value to the security module, which is used when the new module key is produced.

32. The method as claimed in claim 22, wherein the connection to the central system which has been set up using the private module key is used to interchange a symmetrical key for subsequent transaction connections and to store it in the secure key memory in the security module.

33. The method as claimed in claim 22, wherein a mobile personalization unit is used which is connected to the security module directly via a connection which is controlled by a user.

34. The method as claimed in claim 22, wherein a user inputs a one-off transaction number into the security module, either directly using an input unit which is connected permanently to the security module or immediately and directly using an input unit which is connected to the security module by the user, and the connection to the personalization unit is protected by transmitting the transaction number.

35. The method as claimed in claim 22, wherein a mobile appliance is connected to the personalization unit via a local connection to the security module, which local connection is controlled directly by a user, and a long-distance connection, the mobile appliance identifies itself to the personalization unit, and as a result the security module is indirectly identified to the personalization unit.

36. The method as claimed in claim 35, wherein the local and long-distance connections are used merely for securely setting up a secure direct network connection between the security module and the personalization unit.

37. A method for personalizing a security module, comprising the following steps:
connecting a security module to a personalization unit;
connecting the security module temporarily to an identification unit the connection being accomplished by a user using an interface which is determined by the user;
sending via the identification unit, an identification value, which can be checked by the personalization unit, to the security module, which forwards it to the personalization unit; and wherein
the personalization unit performs the personalization if the check on the identity value is positive.

38. The method as claimed in claim 37, where the identification value is a one-off transaction number.

39. The method as claimed in claim 38, where the identification value is interchanged between the identification unit and the personalization unit using a cryptographically authenticated data connection.

40. A security module comprising:
a programmable processor including memory for storing a secure key; at least one data interface for releasably coupling said security module to a personalization unit;
means for creating a module key pair storable in said memory and for sending said module key to said personalization unit;
means for receiving and securely storing a certificate sent from said personalization unit;
operating means for changing said security module from a personalization state to an operating state once said security module is no longer coupled to said personalization unit; and
means for establishing a cryptographically secure connection to a central system using a private module key, said public module key and said certificate.

41. A personalization unit comprising:
at least one data interface for coupling said personalization unit to a security module;
means for receiving a module key via said interface, said module keying being sent from said security module;
means for generating a signing key and producing a certificate regarding said module key, said certificate being produced by signing said module key with said signing key; and
means for sending said certificate to said security module.

42. A central system comprising:
a secure key memory;
at least one data interface;
means for receiving a private module key; a public module key and a certificate from a security module;
means for establishing a cryptographically secure connection to said security module using said public module key, said private module key and said certificate; and
means for checking said certificate.
